(19) United States
(12) Patent Application Publication
(10) Pub. No.: US 2015/0185834 A1
(43) Pub. Date: Jul. 2, 2015

(54) SYSTEM AND METHOD FOR GAZE TRACKING

(71) Applicants: Theodore Charles Wingrove, Plymouth, MI (US); Paul O. Morris, Ann Arbor, MI (US); Kyle Entsminger, Canton, MI (US)

(72) Inventors: Theodore Charles Wingrove, Plymouth, MI (US); Paul O. Morris, Ann Arbor, MI (US); Kyle Entsminger, Canton, MI (US)

(21) Appl. No.: 14/559,561

(22) Filed: Dec. 3, 2014

Related U.S. Application Data
(60) Provisional application No. 61/921,015, filed on Dec. 26, 2013.

(51) Int. Cl. G06F 3/01

(52) U.S. Cl. CPC G06F 3/013

(57) ABSTRACT

A system and method for gaze tracking is disclosed herein. The system includes a tracking device to detect a gaze associated with a user onto either a first feature or a second feature; and a controller, based on a detection of the gaze onto a first feature, configured to associate a mode of operation with a first function, and based on a detection of the gaze onto the second feature, configured to associate the mode of operation with a second function.

### CLAIM OF PRIORITY

This patent application claims priority to U.S. Provisional Application No. 61/921,015, filed Dec. 26, 2013 entitled “System and Method of Gaze Tracking,” now pending. This patent application contains the entire Detailed Description of U.S. Patent Application No. 61/921,015.

### BACKGROUND

User input controls for certain features within a smart device are assigned to specific functions, and a user's input is required to reassign the specific function to a different function. For example, a volume button capable of moving up and down on a smart phone may be used to change the assigned volume of a ringtone, or could be used to change the current playing volume of music from a media player application. The user must interact with the application through touch or voice command to change the function of the feature.

Similarly, different features within a vehicle are controlled and adjusted via its own specific function or switch, button, or user interface. For example, radio volume is adjusted by a volume push button or rotary knob, while an air conditioning unit is adjusted by another rotary knob or push button. Additionally, in some instances, a user may be able to control different features through a variety of menus on a user interface, select a specific feature, and adjust the feature on a touch screen having virtual push buttons or other inputs. Like the smart device, in both instances, the user interacts with an application physical input to control and adjust a feature.

Such physical interactions have become increasingly difficult on users while driving, such as scrolling through different menus to adjust a number of features. Moreover, such physical interactions has led to distracted drivers on the road having to switch between multiple interfaces or menus to adjust features, as well as switching between multiple knobs or buttons to control and adjust certain features.

### SUMMARY

The aspect of the present disclosure provides a gaze tracking system for adjusting a vehicle feature and a method for adjusting a feature within a vehicle with the gaze tracking. The gaze tracking system employs a tracking device, a controller, a user interface, and an input device.

In one aspect, the gaze tracking system may include a tracking device for detecting the movement and direction of a user's eyes on a feature within the vehicle after a predetermined amount of time. The tracking device may be communicatively connected to a controller. The controller may be configured to receive an output signal indicative of a user's eye movement and direction from the tracking device and may also be configured to control and adjust a feature based on the output of the sensor. The gaze tracking system may further include a user interface communicatively connected to the controller configured to display an image for adjusting and controlling the selected feature. Additionally, the gaze tracking system may include an input device configured to adjust the selected feature to the user's preferences.

In another aspect, the method of adjusting a feature within a vehicle utilizing gaze tracking includes detecting the movement and direction of a user's focus via a tracking device. After the movement and direction of the user's focus has been detected, the controller activates the feature as the specified feature to be controlled based on the user's focus. The method further includes adjusting the feature activated by the user's focus using an input device.

The aspects of the present disclosure provide various advantages. For example, the user no longer must interact with physical input controls to activate the menu or feature in which the user desires to control. The user no longer has to interact with multiple physical input controls to control a single feature or multiple features within the vehicle. Instead, the user only has to use a single input device to control multiple features within the vehicle. In addition, the user will be less distracted during driving while trying to utilize multiple input controls to control and adjust a feature.

### BRIEF DESCRIPTION OF THE DRAWINGS

Other advantages of the present disclosure will be readily appreciated, as the same becomes better understood by reference to the following detailed description when considered in connection with the accompanying drawings wherein:

FIG. 1 is an example of an illustration of a user utilizing a gaze tracking system for adjusting a feature within a vehicle in accordance with the present disclosure;

FIG. 2 is an example of a block diagram of the gaze tracking system in accordance with the present disclosure; and

FIG. 3 is an example of a flowchart of a method for adjusting a feature within a vehicle utilizing gaze tracking in accordance with the present disclosure.

FIGS. 4(a), (b) and (c) illustrate an example implementation of the gaze tracking system discussed in FIG. 2 implemented in a vehicle.

### DETAILED DESCRIPTION

Detailed examples of the present disclosure are provided herein; however, it is to be understood that the disclosed examples are merely exemplary and may be embodied in various and alternative forms. It is not intended that these examples illustrate and describe all possible forms of the disclosure. Rather, the words used in the specification are words of description rather than limitation, and it is understood that various changes may be made without departing from the spirit and scope of the disclosure.

The aspects disclosed herein provide a gaze tracking system and method for adjusting a vehicle feature and a method for adjusting a feature within a vehicle employing gaze tracking. The gaze tracking system utilizes a tracking device, a controller, a graphical user interface 26, and an input device.

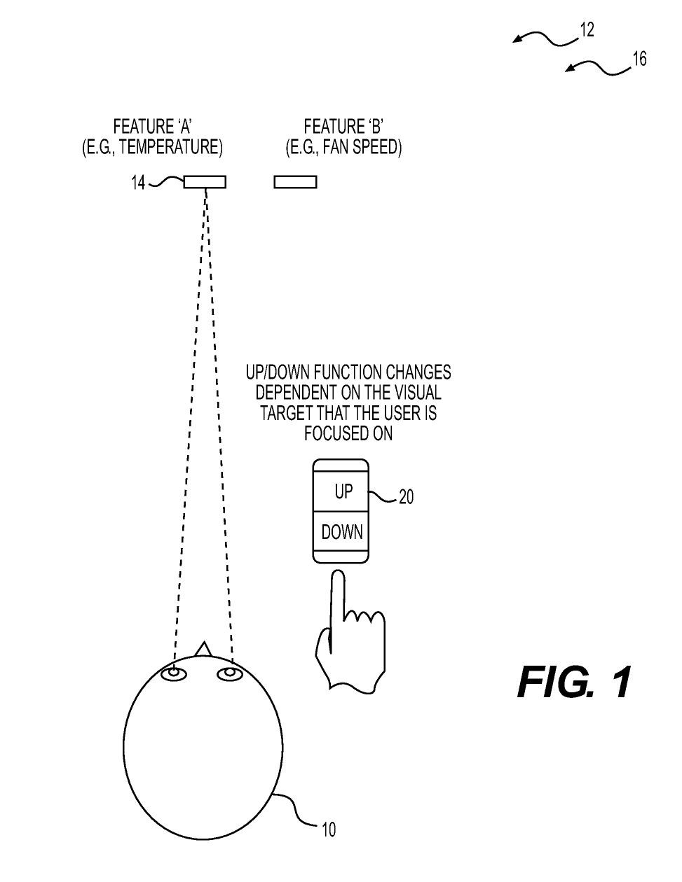

FIG. 1 is an illustration of a user 10 utilizing a gaze tracking system 12 for adjusting a feature 14 within a vehicle 16 in accordance with the present disclosure. As shown in FIG. 1, a user 10 may activate a feature 14 to adjust, such as a temperature control unit and in particular, the temperature and fan speed of the unit. The user 10 may focus on or look at the feature 14 to control the feature 14 for a predetermined amount of time, for example, feature ‘A’ 14. When the user 10 looks at feature ‘A’ 14, which may be a control to adjust the temperature, for the predetermined amount of time, the gaze tracking system 12 may recognize that the user 10 may desire to adjust the temperature and the system 12 may allow the user 10 to control the selected feature 14 by using a input device 20 such as a toggle switch as shown in FIG. 1.

In FIG. 1, feature ‘A’ 14 is shown in two distinct locations. The gaze tracking system 12 may view an exact location of where the gaze is directed at, with a X and Y coordinate associated with the gaze, and triangulate the exact spot that the gaze is directed at.

Additionally, a feature may be embedded on a first feature. For example, the gaze tracking system 12 may notice that a user is looking at a radio, and then triangulate which portion of the radio the user is looking at (i.e. the track selection, the volume, the bass/treble setting, etc). Thus, the feature detection is not limited to a general zone in a singular direction.

Further, two features are shown. However, the number of features implemented is not limited to two.

The input device 20 or toggle switch may have an up/down function. Additionally, the function of the input device 20 or toggle switch may change depending on the visual target or feature 14 that the user 10 is focused on.

For instance, if the user 10 is looking at feature ‘A’ 14 for temperature, the toggle switch may adjust the temperature. Alternatively, if the user is looking at feature ‘B’ and desires to adjust the fan speed of a temperature control unit, the toggle switch may adjust the fan speed. Additionally, the user 10 may first focus on feature ‘A’ 14 to adjust the temperature of the vehicle 16 using the toggle switch and after adjusting the temperature of the vehicle 16, the user 10 may look at the feature ‘B’ to adjust the fan speed. When the user 10 focuses on feature ‘B’, the user 10 may no longer change the temperature of the vehicle 16 using the toggle switch which may now be configured to adjust feature ‘B’ or the fan speed of the temperature control module.

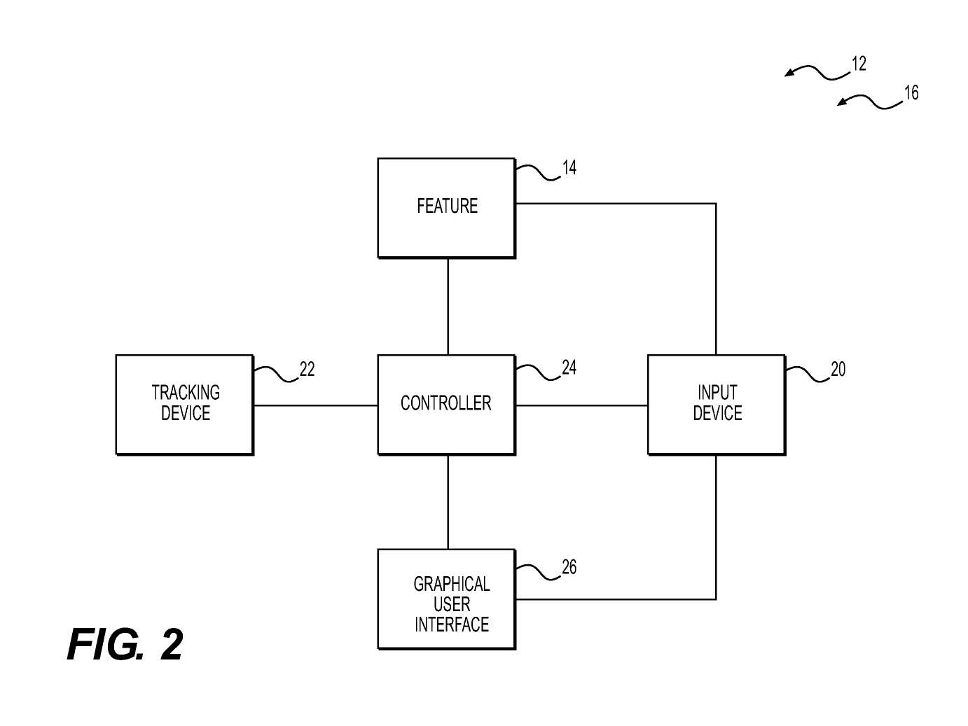

With respect to FIG. 2, a block diagram of a gaze tracking system 12 is provided in accordance with the present disclosure. The gaze tracking system 12 may include a tracking device 22 for detecting the movement or direction of a user's 10 eyes on a feature 14 within the vehicle 16 after a predetermined amount of time.

In one example, the tracking device 22 may be a sensor. Specifically, the sensor may be an infrared sensor or another sensor configured to follow the movement of a user 10's eye. Additionally, the sensor may be a plurality of sensor to tracking each of the user 10's eyes. For example, the sensor may include two infrared sensors which may each individually track one of the user 10's eyes or may track movements of both of the user's 10 eyes at the same time. The plurality of sensors may be used to ensure accuracy in tracking the movement or direction of the user 10's eyes.

The tracking device 22 is not limited to being of a sensor type. In another example, the tracking device 22 may also be, but is not limited to, a camera, a plurality of cameras, or a combination of sensors and cameras.

The gaze tracking system 12 may also include a controller 24. The controller 24 may be communicatively connected to the tracking device 22. The tracking device 22 may have a wired or wireless connection with the controller 24. The controller 24 may have any combination of memory storage such as random-access memory (RAM) or read-only memory (ROM), processing resources or a microcontroller or central processing unit (CPU) or hardware or software control logic to enable management of a controller 24.

Additionally, the controller 24 may include one or more wireless, wired or any combination thereof of communications ports to communicate with external resources as well as various input and output (I/O) devices, such as a keyboard, a mouse, pointers, touch controllers, and display devices. The controller 24 may also include one or more buses operable to transmit communication of management information between the various hardware components, and can communicate using wire-line communication data buses, wireless network communication, or any combination thereof. The controller 24 may be configured to receive an output signal indicative of a user's 10 eye movement and direction from the tracking device 22.

The controller 24 of FIG. 2 may also be configured to control and adjust a feature 14 based on the output of the sensor. In other words, the controller 24 may control and adjust a feature 14 within the vehicle 16 based on the direction of the user's 10 eyes. For example, if the sensor detects the user 10 is focusing on the radio volume, the controller 24 may be configured to recognize that the user 10 is focusing on the radio volume and may be configured to control and adjust the radio volume based on the user's 10 preferences. The controller 24 may use hardware, software, or a combination of hardware and software to automatically control and adjust the feature 14 based on the user 10's focus.

The gaze tracking system 12 may also (however, is not limited to) include a graphical user interface 26 communicatively connected to the controller 24. The graphical user interface 26 may be configured to display different menus of different features 14 within the vehicle 16 such as, but not limited to, radio, satellite radio, MP3, air conditioning, GPS, and telephone. The graphical user interface 26 may have a touch screen and push buttons for selecting different features 14. Additionally, the graphical user interface 26 may be configured to visually display to the user 10, the feature 14 that the user 10 focusing on. For example, if the user 10 is focusing the temperature gauge in the vehicle 16, the graphical user interface 26 may display the virtual temperature gauge. Alternatively, the graphical user interface 26 may display a screen for adjusting and controlling the temperature gauge. In other words, the graphical user interface 26 may display the current temperature within the vehicle 16 and may display the gauge for adjusting the vehicle 16.

FIG. 2 further includes an input device 20. The input device 20 may be communicatively connected to the controller 24 and may be configured to control the feature 14 selected based on the user's 10 gaze detected by the sensor. The input device 20 may also be communicatively connected to any feature 14 within the vehicle 16. The input device 20 may have a wired connection or a wireless connection. Specifically, the input device 20 may be, but is not limited to, a toggle switch having the capabilities of moving up/down, right/left, or both, a push button, a touch screen, voice command, or gesture control. In one example, the input device 20 is a toggle switch which may be moved up or down to change the temperature in the vehicle 16 when the user 10 is looking at the temperature gauge. When the toggle switch is moved up, the temperature increases. Likewise, when the toggle switch is moved down, the temperature decreases. Additionally, the toggle switch may also be communicative connected to and may be displayed on the graphical user interface 26 during use.

Furthermore, the function of the toggle switch may change each time the user 10 changes their focus or gaze on a given feature 14. In other words, the toggle switch may be multi-functional and may be used for every, some or one of the features 14 within the vehicle 16. For example, as discussed in FIG. 1, if the user 10 first focuses on ‘A’ (of feature 14), the toggle switch may be configured to allow an adjustment of a first function (i.e. temperature). After some time, the user 10 may change his/her gaze, and gaze upon feature ‘B’. In response, the toggle switch may be affiliated with a second function (i.e. volume).

A user 10 may focus on a specific feature 14 for a predetermined amount of a time while the tracking device 22 detects the movement or direction of the user's 10 eyes. The tracking devices 22 outputs a signal indicative of detection (based on the user 10 gazing at a feature for a pre-determined time) and the controller 24 determines which feature 14 the user 10 desires to control based on the direction of the user 10's eyes. After the controller 24 determines the feature 14, the user 10 may or may not visually view the feature 14 on the graphical user interface 26 and the user 10 may utilize the input device 20 to control and adjust the function of the feature 14. Additionally, the user 10 may focus on a second point (i.e. ‘B) of feature 14 for a predetermined amount of time in which the system 12 may detect the movement of the user 10's eyes. Based on the user 10's focus, the controller 24 may be configured to control and adjust the second feature 14 utilizing the input device 20.

For example, the user 10 may focus their eyes on the vehicle 16 stereo system for one second after which the user 10's focus is detected by the tracking device 22. The controller 24 then recognizes that the user 10 is focusing on the stereo system and may display different functions on the graphical user interface 26 in which the user 10 may select utilizing the input device 20 such as a toggle switch. The user 10 uses the toggle switch to scroll through different songs and to select the song the user 10 desires to play. After the user 10 selects the song, the user 10 may desire to increase or decrease the volume of the music within the music. As such, the user 10 could gaze onto a volume control of the stereo system, and use the input device 20 to adjust the volume to their preference.

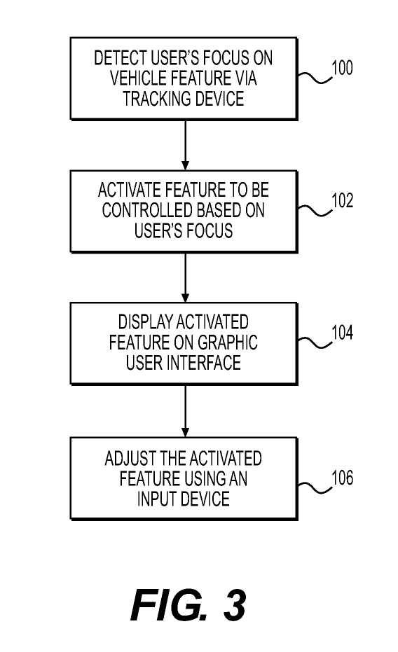

With respect to FIG. 3, a flowchart of a method 300 for adjusting a feature within a vehicle utilizing gaze tracking in accordance with the present disclosure is provided. The method includes detecting the movement and direction of a user's focus after a predetermined amount of time via a tracking device 100. The tracking device may be a sensor, specifically an infrared sensor or a plurality of sensors. Alternatively, the tracking device may be a camera or a plurality of cameras. The tracking device may also be a combination of sensors and cameras. The tracking device may be located anywhere in the front portion of the vehicle.

After the movement and direction of user's focus is detected by the tracking device, the controller automatically activates the feature to be controlled based on the user's focus 102. For example, if the user focuses on the GPS menu within a user interface, the controller will automatically activate the GPS menu as the feature the user desires to control. Additionally, the feature activated may be displayed on the user interface to visually indicate to the user which feature the user will control and adjust 104.

The method further includes adjusting the feature activated by the user's focus using an input device. The input device may be, but is not limited to, a toggle switch, a push button, a touch screen, voice command, or a gesture. The input device may be disposed anywhere within the user's reach. For example, the input device such as a push button or toggle switch may be located near the armrest or on the wheel of the vehicle to allow the user easy access to adjust the feature they have activated. Additionally, the input device allows the user to only utilize one device and adjust every feature within the vehicle. In other words, the input device is multi-functional among the different features within the vehicle. For instance, the user may use the input device to control and adjust the radio within the vehicle and then use the same input device to adjust the air conditioning or temperature within the vehicle based on the user's focus within the vehicle.

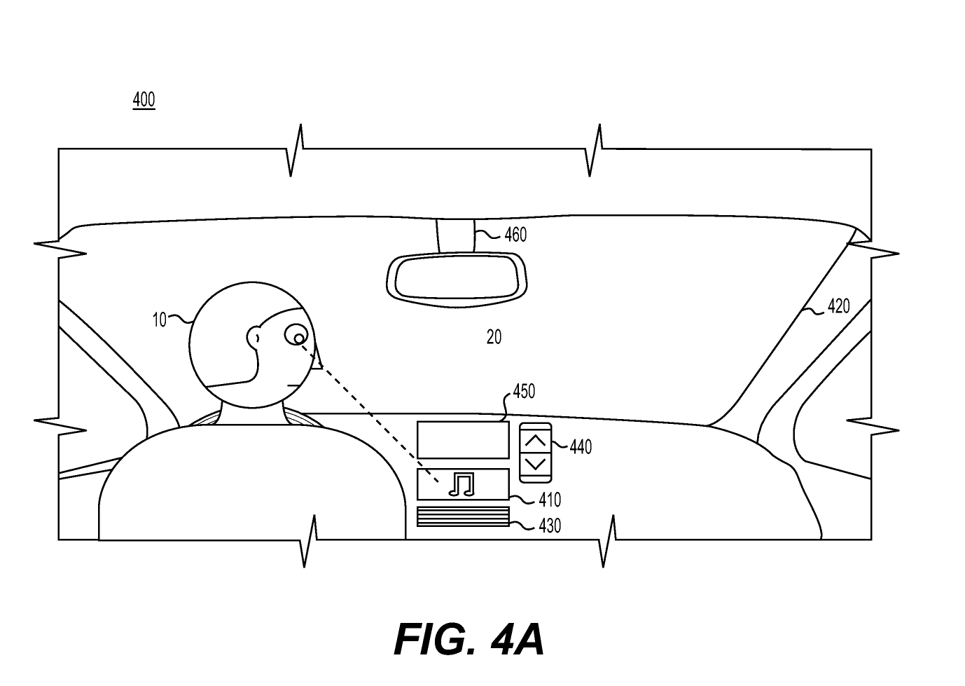

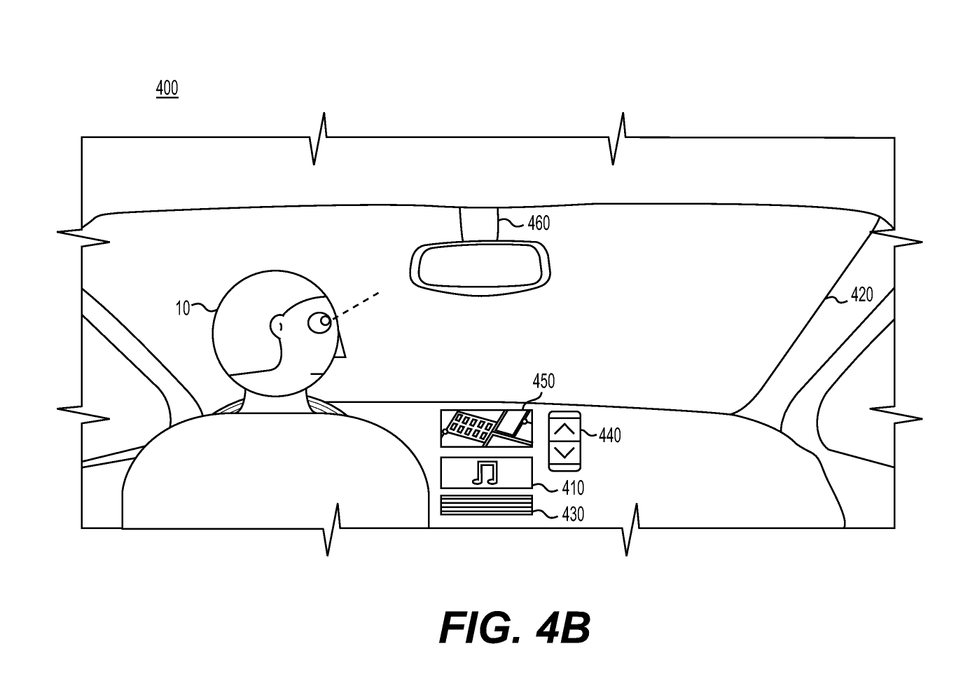

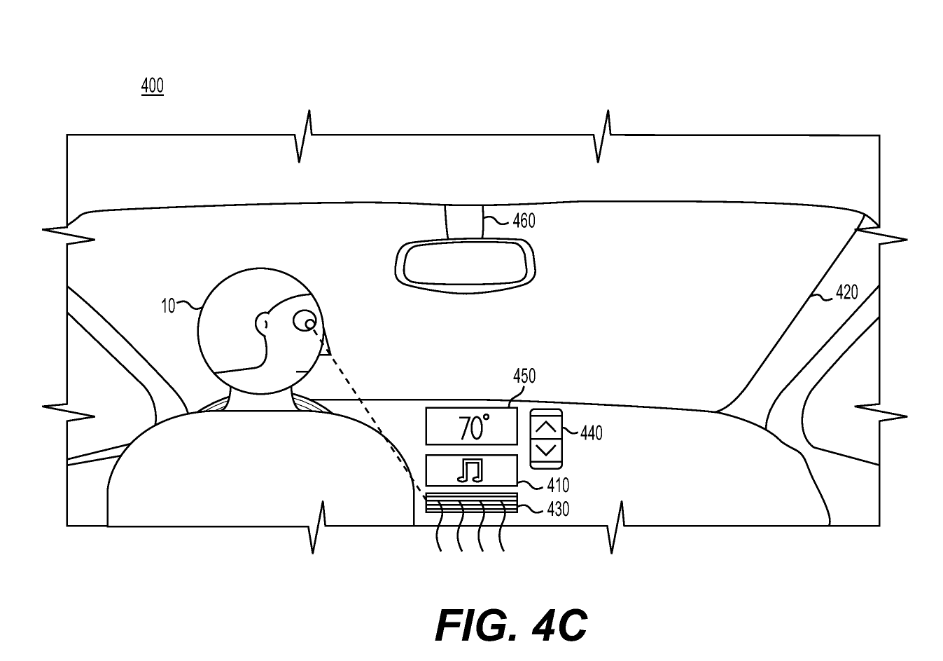

FIGS. 4(a), (b) and (c) illustrate an example implementation of the gaze tracking system discussed above implemented in a vehicle 400. The vehicle 400 includes a display 450 (which may or may not display the graphical user interface 26 discussed above), a radio 410, a windshield 420, and a HVAC unit 430. The vehicle 400 may be situated with a toggle switch 440, connected to an input device 20. As explained above, the toggle switch 440 may be configured to control various aspects associated with gaze tacking system and the vehicular elements discussed above. Thus, the toggle switch 440 may be configured to adjust the volume, the heat, or the display associated with a GPS.

Further, one of ordinary skill in the art may modify the example shown in FIG. 4 based on an implementation preference. Thus the modules and electronic systems installed along with the gaze tracking system may be custom delivered based on an implementer's preference.

Additionally, the gaze tracking system is implemented with both a display 450 and a toggle switch 440. In various embodiments, the gaze tracking system may also be implemented with either the display 450 or the toggle switch 440.

Referring to FIG. 4(a), a user 10 is gazing at the radio 410. Employing the aspects disclosed herein, a tracking device 22 may detect that the user 10 is gazing at the radio 410 (i.e. detecting a head angle rotation or where one's eyes are looking at). In one example, the gaze tracking system may be configured to couple the toggle switch 440 with a function associated with the radio 410 (via input device 20). For example, the toggle switch 440 may be configured to raise or lower the volume, select a song, or switch a radio station.

Referring to FIG. 4(b), the user 10 now gazes at the windshield 420. In the example depicted herein, the display 450 may now be configured to display a function associated with a GPS. Further, the toggle switch 440 may also be configured to operate and interact with the GPS. In the example shown in FIG. 4(b), in one embodiment, the detection of a gaze on the windshield may occur after a predetermined time has lapsed.

Referring to FIG. 4(b), the user now gazes at a HVAC unit 430. Accordingly, the display 450, the toggle switch 440, or both the display 450 and the toggle switch 440 may be configured to operate and interact with the HVAC unit 430.

In the examples described above, a system in a vehicle is described. However, one of ordinary skill in the art may implement the above-described aspects in other systems that share a singular input mechanism to control various functions.

While examples of the disclosure have been illustrated and described, it is not intended that these examples illustrate and describe all possible forms of the disclosure. Rather, the words used in the specification are words of description rather than limitation, and it is understand that various changes may be made without departing from the spirit and scope of the disclosure. Additionally, the features and various implementing embodiments may be combined to form further examples of the disclosure.

We claim:

1. A system for gaze tracking, comprising:
a tracking device to detect a gaze associated with a user onto either a first feature or a second feature; and
a controller, based on a detection of the gaze onto a first feature, to associate a mode of operation with a first function, and based on a detection of the gaze onto the second feature, to associate the mode of operation with a second function.

2. The system according to claim 1, wherein the controller is further configured to switch the associated mode of operation from the first function to the second function, based on the tracking device detecting a switch of the user's gaze from the first feature to the second feature.

3. The system according to claim 2, wherein the controller switches the associated mode in response to the user's gaze occurring for at least a predetermined time amount.

4. The system according to claim 2, wherein the first function and the second function are two of the following: an entertainment system, a HVAC system, a GPS system, a window control system.

5. The system according to claim 1, further comprising an input device, and the mode of operation is controlled via the input device based on the detected gaze.

6. The system according to claim 1, wherein the mode of operation is associated with a specific graphical user interface based on the detected gaze.

7. The system according to claim 5, wherein the mode of operation is associated with a specific graphical user interface based on the detected gaze.

8. The system according to claim 5, where the input device is coupled to a toggle switch.

9. A method for gaze tracking, comprising:
detecting a user's focus on either a first feature or a second feature; and
activating a mode of operation associated with a first function based on a detection of the user's focus onto the first feature, and activating the mode of operation associated with a second function based on a detection of the user's focus onto the second feature.

10. The method according to claim 9, further comprising switching the associated mode of operation from the first function to the second function, based on the tracking device detecting a switch of the user's gaze from the first feature to the second feature.

11. The method according to claim 9, further comprising switching the associated mode in response to the user's gaze occurring for at least a predetermined time amount on the second feature.

12. The method according to claim 9, wherein the first function and the second function are two of the following: an entertainment system, a HVAC system, a GPS system, a window control system.

13. The method according to claim 9, further comprising wherein the mode of operation is controlled via an input device based on the detected gaze.

14. The method according to claim 9, wherein the mode of operation is associated with a specific graphical user interface based on the detected gaze.

15. The method according to claim 13, wherein the mode of operation is also associated with a specific graphical user interface based on the detected gaze.

16. The method according to claim 14, where the input device is coupled to a toggle switch.
